(19) United States
(12) Patent Application Publication
(10) Pub. No.: US 2019/0139049 A1
(43) Pub. Date: May 9, 2019

(54) Order Information Processing Methods, Apparatuses and Systems

(71) Applicant: Alibaba Group Holding Limited, Grand Cayman (KY)

(72) Inventors: Shaohua Li, Hangzhou (CN); Guanghua Hu, Hangzhou (CN); Yuzhou Huang, Hangzhou (CN); Bo Liang, Hangzhou (CN); Lian Wang, Hangzhou (CN); Jiangwei Luo, Hangzhou (CN)

(21) Appl. No.: 16/240,298

(22) Filed: Jan. 4, 2019

Related U.S. Application Data
(63) Continuation of application No. PCT/CN2017/089975, filed on Jun. 26, 2017.

(30) Foreign Application Priority Data
Jul. 6, 2016 (CN) 201610529876.4

(51) Int. Cl. G06Q 20/40; G06Q 10/02; G06Q 50/12; G06Q 50/14

(52) U.S. Cl. CPC G06Q 20/4037; G06Q 20/4097; G06Q 50/14; G06Q 50/12; G06Q 10/02

(57) ABSTRACT

Methods, apparatuses and systems for processing order information are disclosed in the embodiments of the present disclosure. The method includes determining, by a first user data processing system, identification information of a second user when processing a service request of the second user; submitting the identification information of the second user to a server, to enable the server to perform credit authority verification on the second user; generating a service order and submitting the service order to the server after receiving a successful verification message; and submitting consumption resource information of the service order to the server, to enable the server to end the service order according to the consumption resource information. Using the embodiments of the present disclosure, efficiency is improved, and second user who is currently dealt with is avoided from waiting for a long period of time.

### CROSS REFERENCE TO RELATED PATENT APPLICATIONS

This application claims priority to and is a continuation of PCT Patent Application No. PCT/CN2017/089975 filed on 26 Jun. 2017, and is related to and claims priority to Chinese Patent Application No. 201610529876.4, filed on 6 Jul. 2016, entitled “Order Information Processing Methods, Apparatuses, and Systems,” which are hereby incorporated by reference in their entirety.

### TECHNICAL FIELD

The present disclosure relates the technical field of order information processing, and particularly to order information processing methods, apparatuses, and systems.

### BACKGROUND

With the continuous expansion of e-commerce trading platforms and online payment services, the importance of offline to offline (O2O) markets has gradually emerged. “Housing” and “transportation” are very important components in “clothing, food, housing and transportation”, and the pursuit of the qualities of travel services and car rental services has also risen to a new level. In this context, the hotel industry and the car rental industry of the future will need to be upgraded to new levels in aspects such as technical equipment, marketing model, operational efficiency and service concept in order to meet expectations of consumers and enhance competitiveness of the industries.

With the hotel industry is taken as an example, the traditional service of “online reservation and offline check-in” has at least the following problems: First, making a payment is not convenient. At present, in traditional reservation methods and online reservation methods, a user needs to pay a certain deposit more than the room fee by means of cash, bank card pre-authorization, or an online payment tool. The procedure thereof is very cumbersome, and takes up the funds of the user. In addition, due to the uncertainty of a hotel's geographical location and network signals, the user will not be able to use an online payment tool if the online payment tool is used in the hotel. This problem is also a prominent problem encountered in O2O. Another problem is that the front desk of the hotel is inefficient. Procedures for check-in and check-out at the front desk are generally concentrated. Existing methods using a credit card/savings card are inefficient, and require processes such as card waiting, user signing, etc. This often leads to a large number of users waiting, and results in a reduction in the efficiency associated with the hotel and a reduction in the experience of check-in.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides methods, apparatuses and systems for processing order information, which can improve efficiency and prevent a second user which is currently dealt with from waiting too long.

The present disclosure provides the following solutions.

In implementations, an order information processing system may include a first user data processing system and a server, wherein the first user data processing system is configured to determine identification information of a second user and submit the identification information of the second user to the server when processing a service request of the second user; and the server is configured to perform credit authority verification on the second user, notify the first user data processing system to generate a service order if the verification is passed, and in response to receiving consumption resource information corresponding to the service order submitted by the first user data processing system, end the service order according to the consumption resource information and payment account information associated with the second user.

In implementations, an order information processing method may include determining, by a first user data processing system, identification information of a second user when processing a service request of the second user; submitting the identification information of the second user to a server, to enable the server to perform credit authority verification on the second user; generating a service order and submitting the service order to the server after receiving a successful verification message; and submitting consumption resource information of the service order to the server, to enable the server to end the service order according to the consumption resource information and payment account information associated with the second user.

In implementations, an order information processing method may include receiving, by a server, identification information of a second user; performing credit authority verification on the second user; and if the verification is passed, returning a message indicating that the verification is passed to a first user data processing system, to cause the first user data processing system to generate a service order; and receiving consumption resource information of the service order submitted by the first user data processing system, and ending the service order according to the consumption resource information and payment account information associated with the second user.

In implementations, an order information processing method may include generating, by a first user data processing system, a service order according to a service request of a second user; generating a second graphic code according to information of the service order, so that a client of the second user scans the second graphic code when a payment account associated with the second user is logged in, and submits payment account information and service order information that is scanned to a server, and the server performs credit authority verification on the second user according to the payment account information, and returns a message indicating that the verification is passed to the first user data processing system if the verification is passed; receiving the message indicating that the verification is passed; and submitting consumption resource information of the service order to the server, to cause the server to end the service order according to the consumption resource information and the payment account information associated with the second user.

In implementations, an order information processing method may include receiving, by a server, service order information submitted by a client of a second user and payment account information of the second user, wherein the service order is generated by a first user data processing system according to a service request of the second user; performing credit authority verification on the second user according to the payment account information; and returning a message indicating that the verification is passed to the first user data processing system if the verification is passed, to cause the first user data processing system to generate the service order; and in response to receiving consumption resource information of the service order submitted by the first user data processing system, ending the service order according to the consumption resource information and the payment account information associated with the second user.

In implementations, an order information processing method may include obtaining, by a client of a second user, a second graphic code provided by a first user data processing system in a condition that a payment account associated with the second user is logged in, wherein the second graphic code carries service order information generated by the first user data processing system according to a service request of the second user; and submitting payment account information associated with the second user and the service order information in the second graphic code to a server, so that the server performs credit authority verification on the second user according to the payment account information, and returns a message indicating that the verification is passed to the first user data processing system if the verification is passed, wherein the server ends the service order according to consumption resource information and the payment account information associated with the second user.

In implementations, an order information processing apparatus, which is applied in a first user data processing system, may include an identification information determination unit used for determining identification information of a second user when processing a service request of the second user; an information submission unit used for submitting the identification information of the second user to a server, to enable the server to perform credit authority verification on the second user; an order generation unit used for generating a service order and submitting the service order to the server after receiving a successful verification message; and a consumption resource information submission unit used for submitting consumption resource information of the service order to the server, to enable the server to end the service order according to the consumption resource information and payment account information associated with the second user.

In implementations, an order information processing apparatus, which is applied in a server, may include a first information receiving unit used for receiving identification information of a second user; a first verification unit used for performing credit authority verification on the second user; and a first information returning unit used for returning a message indicating that the verification is passed to a first user data processing system if the verification is passed, to cause the first user data processing system to generate a service order; and a first order ending unit used for receiving consumption resource information of the service order submitted by the first user data processing system, and ending the service order according to the consumption resource information and payment account information associated with the second user.

In implementations, an order information processing apparatus, which is applied in a first user data processing system, may include a service order generation unit used for generating a service order according to a service request of a second user; a graphic code generation unit used for generating a second graphic code according to information of the service order, so that a client of the second user scans the second graphic code when a payment account associated with the second user is logged in, and submits payment account information and service order information that is scanned to a server, and the server performs credit authority verification on the second user according to the payment account information, and returns a message indicating that the verification is passed to the first user data processing system if the verification is passed; a message receiving unit used for receiving the message indicating that the verification is passed; and a consumption resource information submission unit used for submitting consumption resource information of the service order to the server, to cause the server to end the service order according to the consumption resource information and the payment account information associated with the second user.

In implementations, an order information processing apparatus, which is applied in a server, may include a second information receiving unit used for receiving service order information submitted by a client of a second user and payment account information of the second user, wherein the service order is generated by a first user data processing system according to a service request of the second user; a second verification unit used for performing credit authority verification on the second user according to the payment account information; and a second information returning unit used for returning a message indicating that the verification is passed to the first user data processing system if the verification is passed, to cause the first user data processing system to generate the service order; and a second order ending unit used for ending the service order according to consumption resource information of the service order submitted by the first user data processing system and the payment account information associated with the second user in response to receiving the consumption resource information.

In implementations, an order information processing apparatus, which is applied in a client of a second user, may include a graphic code acquisition unit used for obtaining a second graphic code provided by a first user data processing system in a condition that a payment account associated with the second user is logged in, wherein the second graphic code carries service order information generated by the first user data processing system according to a service request of the second user; and an information submission unit used for submitting payment account information associated with the second user and the service order information in the second graphic code to a server, so that the server performs credit authority verification on the second user according to the payment account information, and returns a message indicating that the verification is passed to the first user data processing system if the verification is passed, wherein the server ends the service order according to consumption resource information and the payment account information associated with the second user.

According to the embodiments provided by the present disclosure, the present disclosure discloses the following technical effects.

Using the embodiments of the present disclosure, when receiving a service request of a second user, a first user data processing system only needs to submit identification information of the second user to a server. The server can perform credit authority verification on the second user, and perform a determination by judging whether a service condition is satisfied. If satisfied, the first user data processing system is informed to provide services to the current second user according to a preset manner (for example, deposit-free check-in, free of room inspection when leaving the hotel, etc.). At the end of the services, the server then performs a checkout operation for a corresponding order. Therefore, it is possible to avoid performing operations such as collecting a deposit, checking at the time of leaving the hotel, returning a deposit, etc., thus improving efficiency. At the same time, since operations of a process of paying for consumption resources swiping a card (which includes taking out the card, swiping the card, entering a password, and signing), paying cash (taking money, examining the money, giving out any change), etc., are skipped, the second user who is currently dealt with is prevented from waiting for a long period of time.

Apparently, implementing any of the products of the present disclosure does not necessarily require all of the advantages described above to be achieved at the same time.

### BRIEF DESCRIPTION OF THE DRAWINGS

In order to describe the embodiments of the present disclosure more clearly, drawings used in the embodiments are briefly described hereinafter. Apparently, the drawings in the following description represent only some embodiments of the present disclosure. One of ordinary skill in the art can obtain other drawings according to these drawings without making any creative effort.

FIG. 1 is a schematic diagram of an example system in accordance with the embodiments of the present disclosure.

FIG. 2 is a flowchart of a first example method in accordance with the embodiments of the present disclosure.

FIG. 3 is a flowchart of a second example method in accordance with the embodiments of the present disclosure.

FIG. 4 is a flowchart of a third example method in accordance with the embodiments of the present disclosure.

FIG. 5 is a flowchart of a fourth example method in accordance with the embodiments of the present disclosure.

FIG. 6 is a flowchart of a fifth example method in accordance with the embodiments of the present disclosure.

FIG. 7 is a schematic diagram of a first example apparatus in accordance with the embodiments of the present disclosure.

FIG. 8 is a schematic diagram of a second example apparatus in accordance with the embodiments of the present disclosure.

FIG. 9 is a schematic diagram of a third example apparatus in accordance with the embodiments of the present disclosure.

FIG. 10 is a schematic diagram of a fourth example apparatus in accordance with the embodiments of the present disclosure.

FIG. 11 is a schematic diagram of a fifth example apparatus in accordance with the embodiments of the present disclosure.

FIG. 12 is a schematic diagram of an example computing device.

### DETAILED DESCRIPTION

The technical solutions in the embodiments of the present disclosure will be clearly and completely described hereinafter with reference to the drawings in the embodiments of the present disclosure. Apparently, the described embodiments represent merely some and not all of the embodiments of the present disclosure. All other embodiments obtained by one of ordinary skill in the art based on the embodiments of the present disclosure fall within the scope of protection of the present disclosure.

In the embodiments of the present disclosure, a first user may be a merchant or a seller. This type of first user usually provides services to second users, such as a hotel, etc., in a manner of providing service resources such as accommodation, vehicles, and the like. Correspondingly, a second user is a buyer, a consumer, etc. who obtains a corresponding service by using service resources provided by a first user. Specifically, for first users of different categories, specific types of service resources are also different. For example, for a first user of a hotel category, specific service resources may include rooms, facilities in the rooms, etc. For a first user of a car rental category, specific service resources mainly refer to vehicles. For the above application scenarios, since a first user needs to deliver specific service resource to a second user in a process of providing services to the second user, the second user needs to pay a corresponding usage fee. When the second user goes to a store for consumption, the first user usually needs to charge a certain deposit. When the second user leaves the store, a checking operation such as checking a room, checking a vehicle, etc., is performed. If a situation such as a service resource being damaged or lost is found to occur in a process of using the service resources by the second user, the first user may deduct some or all of the deposit as compensation. If the above situation does not occur, the deposit will be refunded to the second user when the second user returns the service resource. However, if operations such as paying a usage fee, paying a deposit, checking, and returning the deposit, etc. are all performed at the front desk of the first user, a relatively long time is usually taken, causing other users to wait in queue for a long time. In addition, a way of collecting a deposit will give a second user a feeling of not being trusted, and the experience of the user is not good.

Accordingly, in the embodiments of the present disclosure, a new order information processing method is provided, wherein resource information of an order may mainly refer to consumption resource information, e.g., information of funds actually consumed by a second user, and the like. In this method, an e-commerce transaction platform can be used to support a process of operation such as resource payment in the above application scenario, so that the second user whose credit authority meets a condition can be exempted from paying a deposit when checking in a hotel, and free from inspection and queuing up when leaving the hotel. When leaving the hotel, a server of the platform directly makes a resource payment for an order. As such, the second user can obtain services more efficiently during a consumption process, and avoid taking up too much resource occupation, obtaining user experience of being trusted and respected. For convenience of description, the above function may be referred to as a “credit-stay” function in the embodiments of the present disclosure.

Specifically, based on the popularity of current online payment tools, every user basically opens his/her own online payment account, for example, an Alipay account, etc. Therefore, the embodiments of the present disclosure provide an order information processing service to a first user and a second user according to the above situations. Specifically, when a second user goes to an offline store of a first-user to perform procedures related to services such as room check-in or car rental, identification information of the second user can be submitted to a server that is capable of providing functions such as “credit-stay” through a variety of means. The server may perform credit authority verification on the second user to determine whether a preset service condition is satisfied, for example, whether information such as a degree of credibility satisfies the service condition. If being satisfied, the first user may be notified to process a deposit-free check-in or free deposit-free car rental for the second user, etc. In other words, the server provides a “credit endorsement” for users who open a payment account and have a relatively high credit rating. As such, the second user does not need to pay the first user for a room fee, a deposit, etc. when checking in or renting a car, thus avoiding an excessive occupancy of the second user's funds, and shortening waiting times of other users who are being processed with. When leaving the store, service resources can be directly returned. The first user does not need to perform operations such as checking the room and inspecting the car, and a situation of a deposit refund does not exist. The second user can leave the store directly, and an automatic transfer of a subsequent payment of the room fee, etc can be made by the server in the embodiments of the present disclosure.

It should be noted that the “hotel”, “car rental” and the like mentioned in the foregoing description are mainly used for the purpose of illustrating specific implementations of the embodiments of the present disclosure, and should not be construed as limitations to the scope of the embodiments of the present disclosure.

Exemplary implementations are described in detail hereinafter.

### First Embodiment

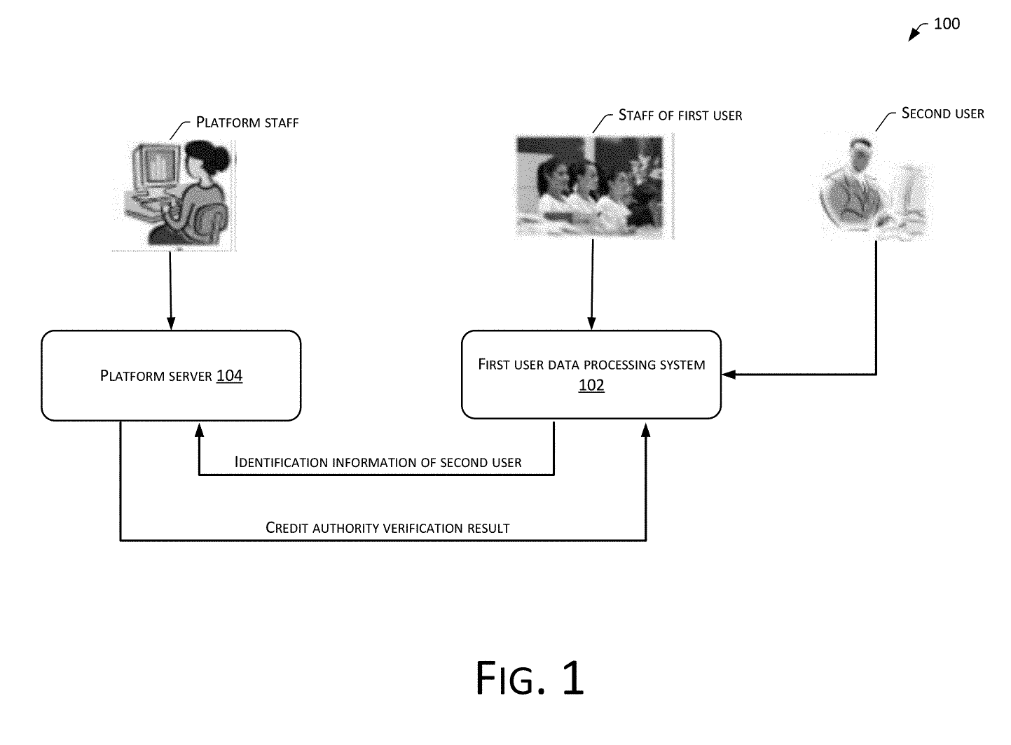

First, the first embodiment provides an order information processing system 100 from the perspective of the system 100. Referring to FIG. 1, the system 100 may include a first user data processing system 102 and a platform server 104. The first user data processing system 102 is configured to determine identification information of a second user when processing a service request of the second user, and submit the identification information of the second user to the server. The platform server 104 is configured to perform credit authority verification on the second user, notify the first user data processing system 102 to generate a service order if the verification is passed, and end the service order according to consumption resource information corresponding to the service order submitted by the first user data processing system 102 and payment account information associated with the second user in response to receiving the consumption resource information.

In practical applications, the first user data processing system may refer to a PMS (Property Management System) system of a hotel, etc. The service order may refer to a service order of the hotel, and the like. In this type of scenario, when a second user enters the hotel to check in, the PMS of the hotel can collect identity authentication information of the second user and upload the identity authentication information to the server (for example, a server of the Ali travel platform, etc.). According to “Zhima credit” of the second user and other data, the server performs credit authority verification on the second user. If passed, the PMS system of the hotel can generate a special service order, the particularity of which being reflected in that: the second user does not need to pay a deposit, and does not need to pay a room fee in advance; offline resources can be directly allocated to the second user, with the second user being able to check in directly; operations such as checking the room and refunding the deposit do not need to be performed when the second user leaves the hotel; and the server of the Ali travel platform, for example, can directly transfer relevant resource information from an account associated with the second user into an account of the hotel. As can be seen, “credit=wealth” is truly embodied in the embodiments of the present disclosure. What is consumed by the second user before leaving the hotel is his/her own credit, and resources such as real funds are actually consumed only after leaving the hotel at the end. This is also the biggest difference between the embodiments of the present disclosure and credit card consumption.

The technical solutions of the embodiments of the present disclosure are described in detail in the following embodiments from the perspective of more specific implementations.

### Second Embodiment

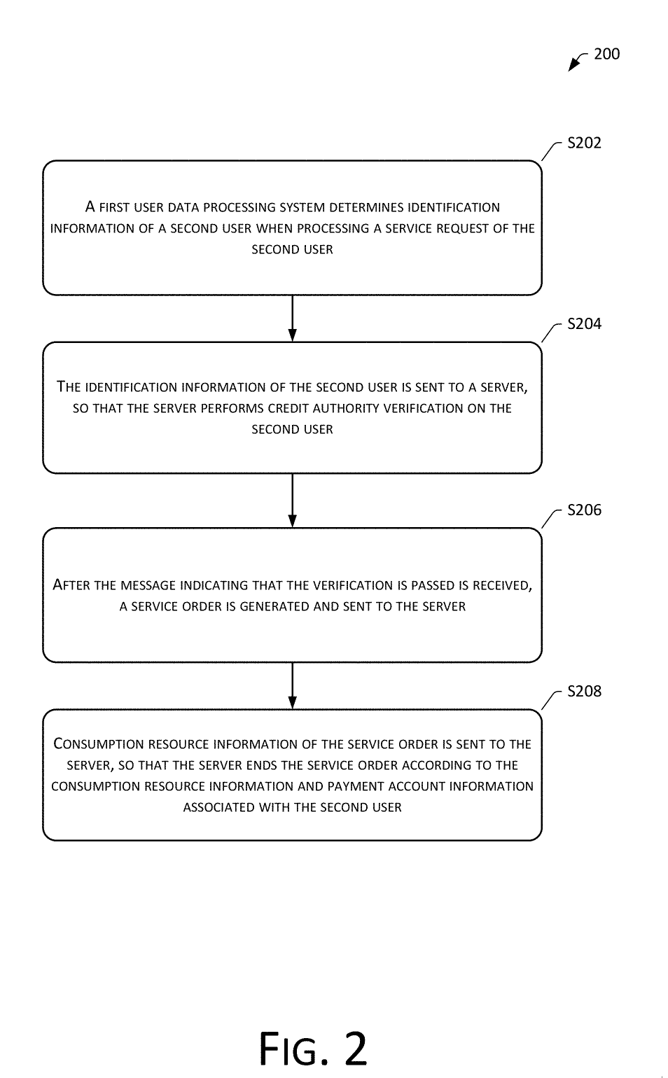

The second embodiment provides a method 200 for processing order information from the perspective of a first user data processing system. Referring to FIG. 2, the method 200 may include the following operations.

S202: A first user data processing system determines identification information of a second user when processing a service request of the second user.

The first user data processing system may be an enterprise management platform client used by a first user. This type of enterprise management platform client may establish a cooperative relationship with a server that is capable of providing a “credit-stay” function. Among the two parties, each party can open a standardized interface for the opposite party in advance, thus enabling direct communications between the two parties. Alternatively, the first user data processing system may also be provided to the first user by a server providing a “credit-stay” function. For example, when providing a server having a “credit-stay” function, an Ali travel platform may also provide a first user client providing Ali travel.

In the embodiments of the present disclosure, a specific application scenario may be: when a second user goes to an offline store of a first-user to check-in or rent a car, etc. (i.e., what is conducted between the second user and the first user is an offline transaction), the second user does not pre-book on an e-commerce transaction platform, but directly goes to the offline store of the first-user to check-in or rent a car, etc. At this time, what is received by a first user data processing system is a service request of the second user. Alternatively, the second user may also make a reservation from another e-commerce transaction platform in advance (“other” herein is referred to as: if a “credit-stay” service in the embodiments of the present disclosure is provided by a Tao-series platform such as Ali Travel or Alipay, other sales platforms that provide online reservation services for travel and car rental are called “other e-commerce transaction platforms”, but has not made a payment yet. For the above various types of situations, the solutions provided by the embodiments of the present disclosure can be used to achieve highly efficient processing, thereby avoiding long waiting times for users.

In other words, when the second user goes to the offline store of the first-user to process an offline transaction, or when the second user makes a reservation through another e-commerce platform and goes to the offline store of the first-user to check in, the first user data processing system can determine the identification information of the second user. Such information is provided to the server in a subsequent operation, and the server determines whether the “credit-stay” can be performed.

A plurality of specific forms of the identification information of the second user may exist, as long as the server can identify which specific payment account corresponds thereto. For example, in one implementation, since the first user usually needs the second user to present his/her identity document and perform registration according to national laws and regulations etc., when the second user goes to the first user's offline store to check in, the first user can collect information of the identity document of the second user, for example, an identity number, a name, etc. When the second user opens his/her own payment account in a payment platform, the payment platform usually also performs real-name authentication on the second user, which includes requesting the second user to input information of an identity document, and recording thereof. In other words, the second user opening the payment account in the payment platform actually records information of real-name identity document of the second user in the payment platform. Therefore, the first user data processing system can collect the information of the identity document of the second user and submit the information as the identification information of the second user to the server. The server and the payment platform at which the user opens the payment account may have an association relationship. For example, the Ali travel platform and the Alipay platform have an association relationship therebetween, etc. In this way, the server can determine information of the payment account corresponding to the information of the identity document according to real-name authentication information that is stored. Further, since the server usually records credit information and the like associated with the information of the payment account, and thus a determination is made as to whether the second user satisfies a preset service condition based on the information of the payment account.

The convenience of the above method is that the first user data processing system only needs to submit collected information of an identity document of a second user to the server when the solutions provided by the embodiments of the present disclosure are used because collecting the information of the identity document of the second user and registering the information by the first user belong to legal procedures. Therefore, a client of the second user is prevented from performing additional operations excessively, which is beneficial to improve processing efficiency.

In addition, other methods of implementations can also be implemented. For example, one method may be that the first user data processing system may obtain payment account information associated with the second user, and then submit the payment account information to the server as the information of the second user. The payment account information is the information of the payment account registered by the second user in the payment platform associated with the server may be used, so that the server may directly determine whether the credit authority of the second user satisfies a service condition according to the payment account information associated with the second user. A number of particular ways of implementations in which the first user data processing system obtains the payment account associated with the second user can exist. For example, the second user may tell the character included in the payment account to a staff of the first user by means of a verbal description. In this way, the staff of the first user can input the character of the payment account of the second user through a keyboard entry. Alternatively, since the second user usually carries a mobile terminal device such as a mobile phone with him or her, a user interface of a payment platform client program usually provides and carries a first graphic code (such as a barcode, a two-dimensional code, etc.) associated with the payment account information if the payment platform client program is installed in the device. Therefore, in this case, the second user can also open the payment platform client program (for example, Alipay) in the mobile terminal device, and select an option of “payment” or the like from the interface, thus displaying the first graphic code which carries the payment account information associated with the second user. At the same time, a terminal device of the first user can be connected to a code scanning device such as a code scanner, so that the staff of the first user can scan the first graphic code displayed in the interface of the second user terminal device using the code scanning device, thereby obtaining the payment account information associated with the second user.

Through the above methods, although the first user data processing system needs to obtain the payment account information associated with the second user by means of inputting or scanning, etc., the server can directly determine whether the second user satisfies the service condition based on the payment account information associated with the second user can be directly used, without the need of first determining the payment account information based on identification information of the second user. Therefore, the processing efficiency of the server can be improved, and the processing efficiency of the entire process of processing can be improved as a whole.

S204: The identification information of the second user is sent to a server, so that the server performs credit authority verification on the second user.

After the identification information of the second user is submitted to the server, the server may determine whether the credit authority of the second user meets a preset service condition. A specific service condition may be determined according to actual service requirements. For example, a limitation may be made on the credit rating of the second user, the size of the credit limit, the number of outstanding transaction orders, and the like. In this way, the server specifically determines a parameter value corresponding to the current second user based on various parameters involved in the service condition, and compares the parameter value with a threshold value defined in the condition, thereby determining whether the second user satisfies the service condition. For example, under the Alipay platform, the “Zhima credit” information associated with an Alipay account of the second user may be obtained, and quota information provided to the second user by “ant flower garden” may also be obtained. In addition, the number of outstanding orders associated with the Alipay account, etc., can also be determined. The above factors can be used to determine whether the current second user satisfies the service condition.

In addition, the first user data processing system may further provide predicted consumption resource information (which may be calculated, for example, according to a unit price of a service resource and an estimated check-out date, etc.) and provide the estimated consumption resource information to the server. As such, the server may firstly determine a degree of credibility of the second user. If the condition is satisfied, credit limit information of the second user may also be determined, and whether a credit limit of the user is greater than the currently predicted consumption resource information is determined. If being greater, the condition is met.

In response to determining that the second user satisfies the service condition, the first user data processing system may return a message indicating that the verification is passed. For example, the first user can be notified to process the current second user with a deposit-free check-in, or a deposit-free car rental, etc., by means of a notification message, etc.

S206: After the message indicating that the verification is passed is received, a service order is generated and sent to the server.

After the first user data processing system receives the message indicating that the verification is passed, the second user can directly use a service resource allocated by the first user, and operations such as making a payment for a room fee and a deposit, performing an inspection, refunding the deposit, etc., do not need to be performed, thus avoiding additional occupancy of the second user's funds, improving processing efficiency, and preventing other second users from waiting in a queue for a long time. In other words, when the second user checks in, no payment of any fee is needed. The first user directly allocates a room for him/her, and the second user can directly check in.

In addition, after receiving the message indicating that the verification is passed from the server, the first user data processing system may further generate a service order, i.e., an order within the first user system. The service order may include an order identification of the first order, identifier information of the first user, identifier information of the second user, and the like. In this way, information of the service order can also be provided to the server, so that the server performs other processing operations on the service order.

S208: Consumption resource information of the service order is sent to the server, so that the server ends the service order according to the consumption resource information and payment account information associated with the second user.

In practical applications, in addition to performing a “credit endorsement” for the second user in order to implement a credit consumption service, the server may also assist the second user to complete a payment for resource(s) that is/are consumed (for example, a payment of a room fee, etc.) generated during the use of service resources. In other words, as described above, in the embodiments of the present disclosure, when a second user goes to an offline store of a first user for consumption, no resource usage fee has yet been paid. In order to further improve the efficiency and avoid the excessive time occupancy caused by the second user making a payment by paying cash, swiping a card, etc., the server may also perform a settlement operation, i.e., directly transfer relevant consumption resources from an account of the second user to an account of the first user. This operation can be completed directly online, without the need for the second user to perform operations such as paying cash, swiping a card or using another third-party payment tool, etc.

In implementations, the server can determine payment account information associated with the second user after receiving the service order, and can also determine payment account information associated with the first user. The server can further bind information of a collection account of the first user, the payment account information of the second user and the service order, and generates a payment order. The payment order belongs to an order inside a payment platform, and is used for making a direct transfer from the payment account of the second user to the collection account of the first user when the second user pays an actual usage fee of the service resources at a later stage. The payment order may be invisible to the first user data processing system, and only a user payment system performs processing of specific resource information.

Specifically, after the service process ends, the first user data processing system may further determine actual consumption resource information according to an actual number of days of use of the service resources by the second user, and send the actual consumption resource information and an order status of the service order to the server. As such, the server determines a corresponding payment order according to an order identifier of the service order, and allocates funds according to information recorded in the payment order and the actual consumption resource information. In implementations, in order to realize a real allocation operation of the consumed resources, a settlement order may be generated. The settlement order is an order for performing a settlement operation. According to the settlement order, corresponding actual consumption resource information is allocated from the payment account of the second user to the collection account of the first user. Apparently, such transfer order is usually used for fulfilling conventional processing methods in existing payment systems such as Alipay, so as to avoid too many modifications of handling processes of the existing payment systems. In other words, such transfer order may not need to be generated in other payment systems, and resources can be directly transferred based on the information recorded in the payment order.

In practical applications, the service order generated by the first user data processing system may further include service resource allocation result information, estimated consumption amount information, a service starting time, and an estimated service ending time, etc. In this way, the server can also record these pieces of information, and the second user can conduct an inquiry by logging into his/her own payment account or the like. Moreover, this part of information may also be used for determining whether the second user satisfies the service condition. For example, a determination may be made as to whether a credit limit of the second user is greater than the estimated consumption resource information, etc.

In summary, in the embodiments of the present disclosure, in response to receiving a service request of a second user, a first user data processing system only needs to submit identification information of the second user to a server. The server can perform credit authority verification on the second user and perform a determination by judging whether a service condition is satisfied. If satisfied, the first user data processing system is informed to provide services to the current second user according to a preset manner (for example, deposit-free check-in, free of room inspection when leaving the hotel, etc.). At the end of the services, the server then performs a checkout operation for a corresponding order. Therefore, it is possible to avoid performing operations such as collecting a deposit, checking at the time of leaving the hotel, returning a deposit, etc., thus improving efficiency. At the same time, since operations of a process of paying for consumption resources swiping a card (which includes taking out the card, swiping the card, entering a password, and signing), paying cash (taking money, examining the money, giving out any change), etc., are skipped, the second user who is currently dealt with is prevented from waiting for a long period of time.

### Third Embodiment

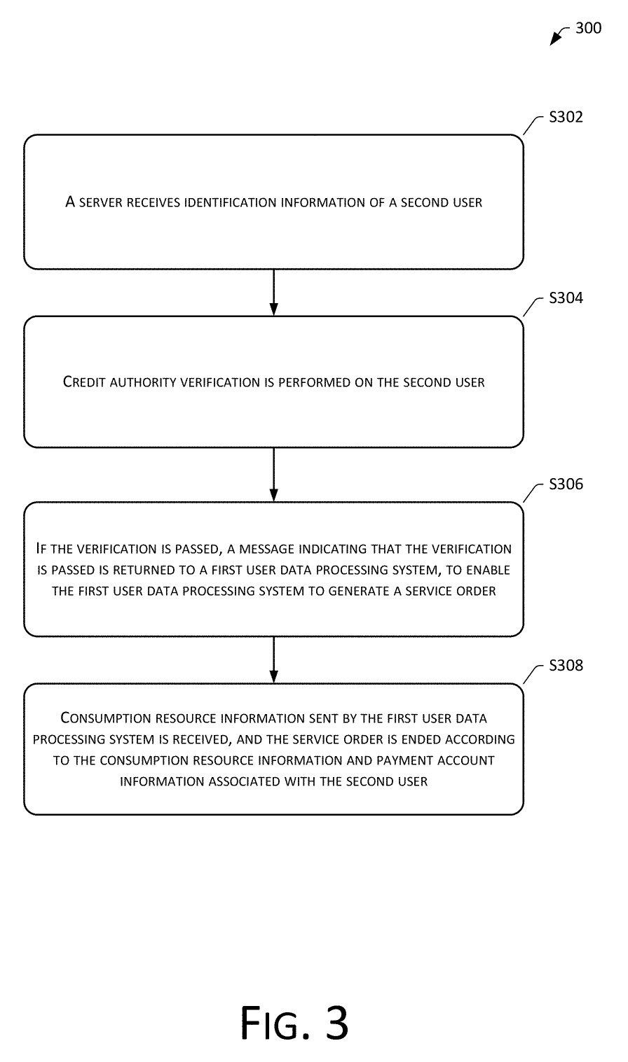

The third embodiment corresponds to the second embodiment, and is described from the perspective of a server. Referring to FIG. 3, the third embodiment provides a method 300 for processing order information, which may include the following operations.

S302: A server receives identification information of a second user.

The identification information may be submitted by a first user data processing system when processing a service request of the second user.

The server herein refers to a server that provides support for a “credit-stay” service. For example, if a system such as Ali Travel, Alipay, etc., provides support for a “credit-stay” service, the server herein can refer to a server of Ali Travel, a server of Alipay, etc.

S304: Credit authority verification is performed on the second user.

S306: If the verification is passed, a message indicating that the verification is passed is returned to a first user data processing system, to enable the first user data processing system to generate a service order.

S308: Consumption resource information sent by the first user data processing system is received, and the service order is ended according to the consumption resource information and payment account information associated with the second user.

The received identification information that is sent by the first user data processing system may include identity document information of the second user. At this time, the server may determine information of a payment account of the second user that is opened in a payment platform associated with the server according to the identity document information, and determine whether the credit authority of the second user satisfies a preset service condition according to the information of the payment account. If the received identification information that is sent by the first user data processing system is payment account information associated with the second user, a determination of whether the second user satisfies the preset service condition can be directly made based on the payment account information. In addition, In implementations, the information sent by the first user data processing system further includes estimated consumption resource information. At this time, credit limit information of the second user may also be determined, and whether the credit limit information is higher than the estimated consumption resource information is determined. Based on a determination result thereof, a determination of whether the verification is passed is made.

Ending the service order may mainly include performing operations such as paying for resources that are consumed for the service order, and the operations may be completed by the server. Specifically, in order to perform settlement processing on the service order, the server may further receive service order information sent by the first user data processing system. The server may then determine information of a collection account of the first user according to identifier information of the first user, and bind the determined information of the collection account of the first user, information of a payment account of the second user, and the service order to generate a payment order.

When the second user processes a procedure of leaving a hotel or returning a vehicle, actual consumption resource information and the corresponding service order identifier sent by the first user data processing system may be received after consumption by the second user is finished. The server may determine a corresponding payment order according to an order identifier of the service order, and then generate a transfer order according to information recorded in the payment order and the actual consumption resource information. The server may further transfer the corresponding actual consumption resource information from a payment account of the second user to a collection account of the first user. Thereafter, a notification message regarding the transfer of resource information may also be provided to a client of the second user.

In addition, it should be noted that, in a process of determining whether a second user credit authority satisfies a service condition, information such as a credit limit of the second user, payment order records, and the like, may be read, and an automatic fund transfer from a payment account of the second user to the collection account of a first user may be involved after consumption ends. Therefore, a contract may be signed with the second user in advance, i.e., various specific operations in the embodiments of the present disclosure are performed in a condition that the second user has agreed thereto. Accordingly, upon receiving identification information of a second user submitted by the first user data processing system, the server can also first determine whether the current second user is a contracted user in an event that a determination is made that the second user is needed to perform credit authority verification. If affirmative, operations such as determination are performed. Otherwise, the second user may be prompted to sign a contract.

A number of specific prompting methods can exist. For example, if information of a second user received by the server includes contact information of the second user, information of a link for jumping to a contract signing page can be provided to the second user using the contact information. For example, the information of the link is sent to the second user's mobile phone through a short message, etc. In this way, after the second user clicks on the link, a client of the second user can be invoked, and the contract signing page is displayed. User operation information submitted by the client of the second user is thereby received, and thus a signing operation can be completed.

Alternatively, in another implementation, the offline store of the first user may provide a graphic code carrying an address of the contract signing page, such as a two-dimensional code. The server may send contract prompt information to the first user data processing system, and a staff of the first user may prompt the second user to use the client of the second user to scan the two-dimensional code to directly display the contract signing page and perform an operation of signing a contract.

Furthermore, the first user data processing system may also provide an option of operation for completing signing of a contract. At this time, the server may provide the first user data processing system with prompt information indicating that the second user has not signed a contract. A staff of the first user can verbally read the content of an agreement and ask the second user whether he/she agrees. With the consent of the second user, the staff of the first user can operate on the option of operation of the first user data processing system to achieve a verbal contract. It should be noted that, in this manner, after receiving information of the verbal contract, the server may change the payment account of the second user information into a status indicating a contract being agreed because the information of the payment account of the second user has been previously determined based on the information of the second user. Alternatively, the server may treat the verbal contract as a temporary contract, i.e., being valid in the current purchase only, or being valid for the current first user only, etc.

Since the third embodiment corresponds to the second embodiment, relevant implementation details can be referenced to the description in the first embodiment, and details thereof are not repeatedly described herein.

### Fourth Embodiment

In the foregoing second and third embodiments, identification information of a second user is sent from the first user data processing system to the server, which may be identity document information of the second user, or may be payment account information of the second user that obtained by methods such as code scanning. In the fourth embodiment of the present disclosure, payment account information associated with a second user may be submitted to the server by a client of the second user, which is described in detail below.

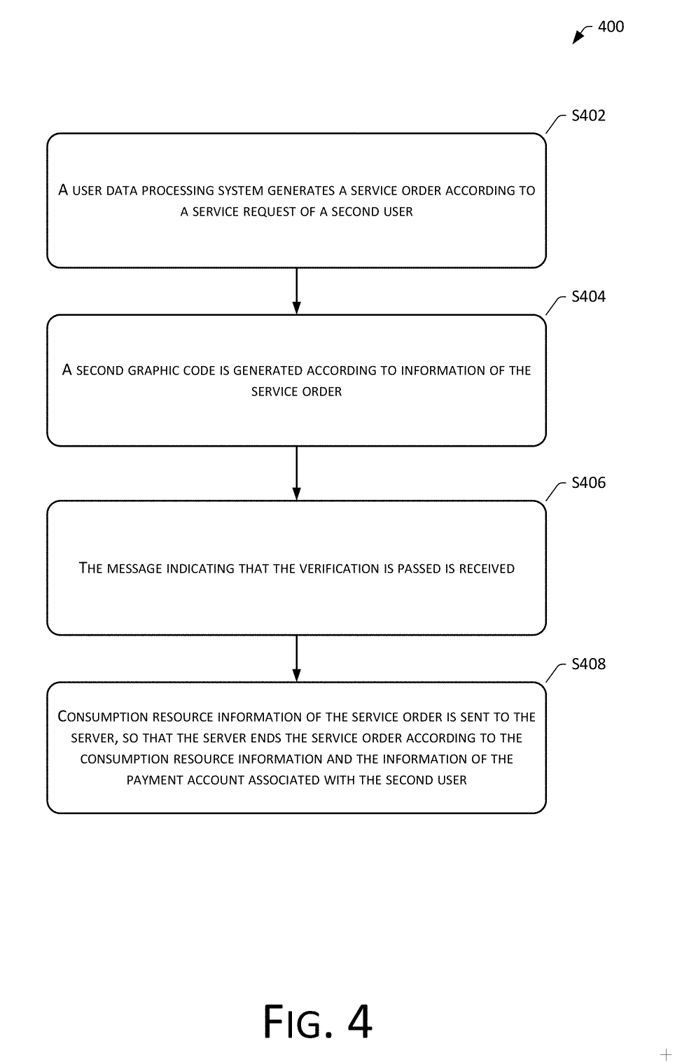

Referring to FIG. 4, the fourth embodiment provides a method 400 for processing order information, which may include the following operations.

S402: A user data processing system generates a service order according to a service request of a second user.

Apparently, in practical applications, the service order may further include an identifier of the order, an identifier of the second user, service resource allocation information, estimated consumption resource(s), a service starting time, an estimated service ending time, etc. The server can make a record thereof, and further generate an order within a payment system used for paying actual resource(s) that is/are consumed, etc.

S404: A second graphic code is generated according to information of the service order, to allow a client of the second user to scan the second graphic code when a payment account associated with the second user is logged in, and payment account information and scanned information of the service order is sent to a server, which performs credit authority verification on the second user according to information of the payment account, and returns a message indicating that the verification is passed to the first user data processing system if satisfied.

The client of the second user may refer to an Ali travel client, an Alipay client, and the like, that is installed in a terminal device of the second user. Since the client of the second user is in a state in which the payment account associated with the second user is logged in, a scanning result may be sent to the server together with information of the payment account of the second user after scanning. The server determines whether the second user satisfies a service condition. In addition, since the service order includes identifier information of the first user, the server may provide a notification message to the first user data processing system in response to determining that the second user satisfies the service condition.

S406: The message indicating that the verification is passed is received.

S408: Consumption resource information of the service order is sent to the server, so that the server ends the service order according to the consumption resource information and the information of the payment account associated with the second user.

After receiving the message indicating that the verification is passed is received, the first user data processing system may also perform services such as free deposit and free room check for the second user.

### Fifth Embodiment

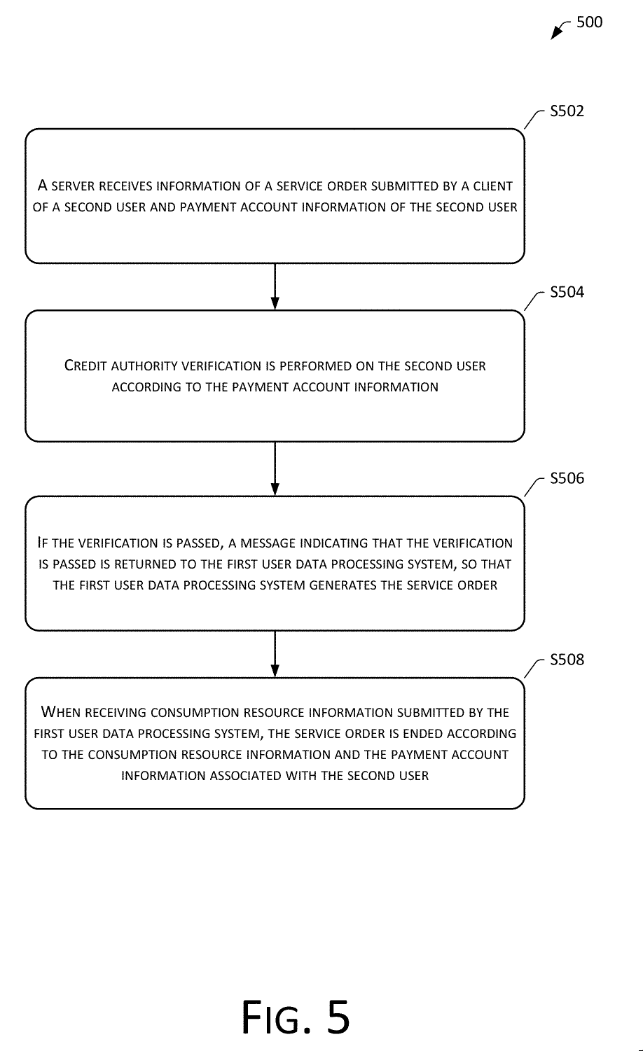

The fifth embodiment corresponds to the fourth embodiment and is described from the perspective of a server. Referring to FIG. 5, the fifth embodiment provides a method 500 for processing order information, which may include the following operations.

S502: A server receives information of a service order submitted by a client of a second user and payment account information of the second user, where the service order is generated by a first user data processing system according to a service request of the second user.

S504: Credit authority verification is performed on the second user according to the payment account information.

S506: If the verification is passed, a message indicating that the verification is passed is returned to the first user data processing system, so that the first user data processing system generates the service order.

S508: When receiving consumption resource information submitted by the first user data processing system, the service order is ended according to the consumption resource information and the payment account information associated with the second user.

### Sixth Embodiment

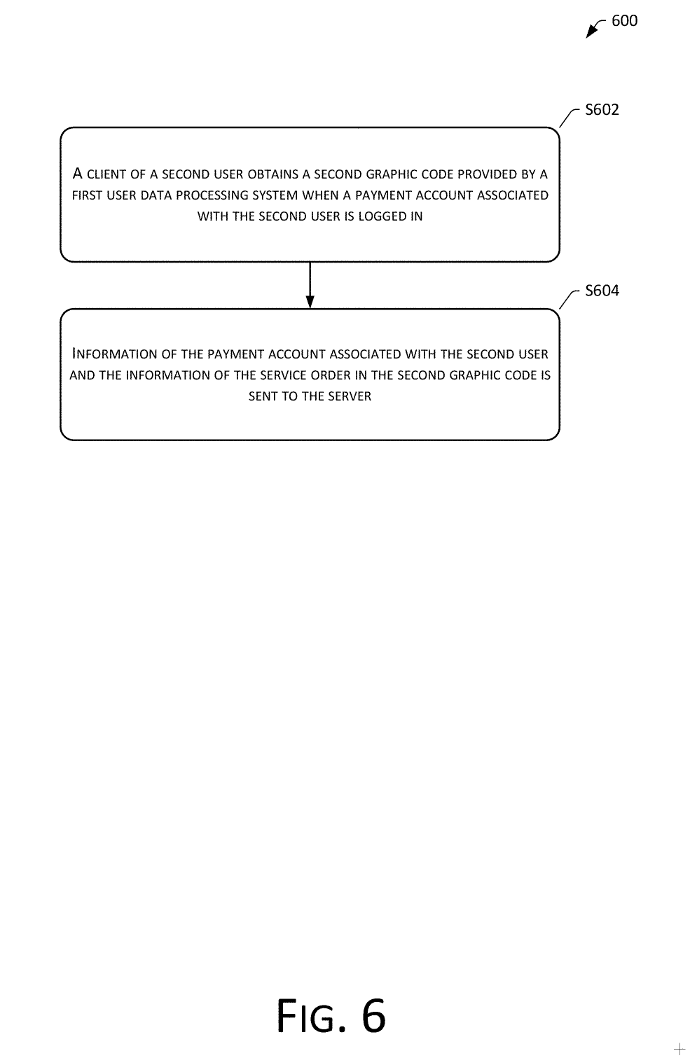

The sixth embodiment also corresponds to the fourth embodiment, and provides an order information processing method 600 from the perspective of a client of a second user. Referring to FIG. 6, the method 600 may include the following operations.

S602: A client of a second user obtains a second graphic code provided by a first user data processing system when a payment account associated with the second user is logged in, wherein the second graphic code carries information of a service order generated by the first user data processing system according to a service request of the second user.

S604: Information of the payment account associated with the second user and the information of the service order in the second graphic code is sent to the server, so that the server performs credit authority verification on the second user according to the information of the payment account, and returns a message indicating that the verification is passed to the first user data processing system if the verification is passed, the server ending the service order according to consumption resource information and the information of the payment account associated with the second user.

It should be noted that other details of implementations in the fourth to sixth embodiments may be the same as those in the second embodiment. Therefore, reference may be made to the description in the second embodiment, and details thereof are not repeatedly described herein.

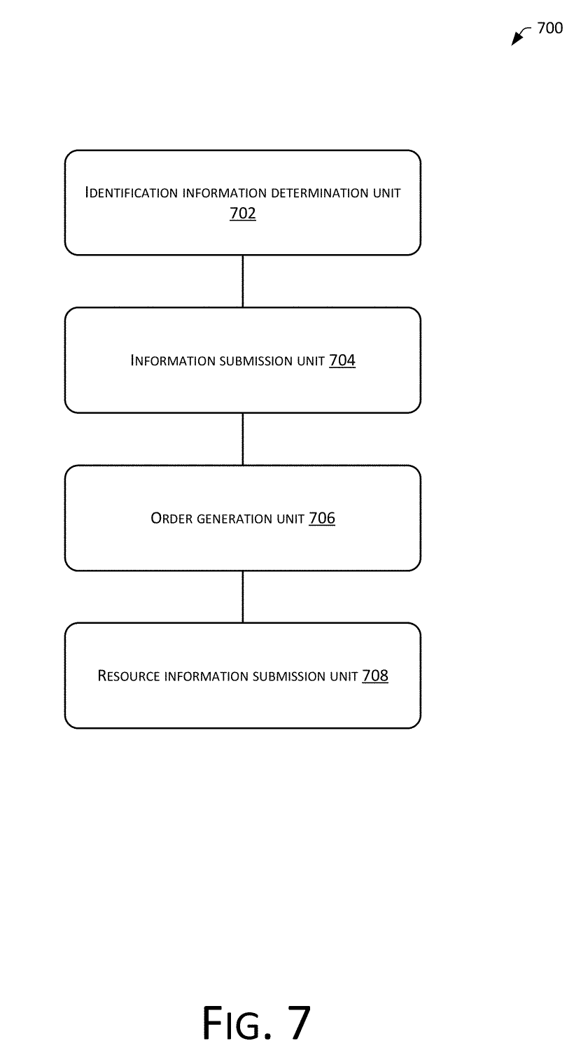

Corresponding to the second embodiment, the embodiments of the present disclosure further provide an order information processing apparatus 700, which is applied in a first user data processing system. Referring to FIG. 7, the apparatus 700 may include an identification information determination unit 702 used for determining identification information of a second user when processing a service request of the second user; an information submission unit 704 used for submitting the identification information of the second user to a server, to enable the server to perform credit authority verification on the second user; an order generation unit 706 used for generating a service order and submitting the service order to the server after receiving a successful verification message; and a consumption resource information submission unit 708 used for submitting consumption resource information of the service order to the server, to enable the server to end the service order according to the consumption resource information and payment account information associated with the second user.

In implementations, the identification information determination unit 702 may further be used for collecting identity document information of the second user, and the information submission unit 704 may further be used for sending the identity document information of the second user to the server, so that the server determines the payment account information opened by the second user in a payment platform associated with the server according to the identity document information, and performs the credit authority verification on the second user based on the payment account information.

Alternatively, in implementations, the identification information determination unit 702 may be further used for obtaining the payment account information opened by the second user in a payment platform associated with the server, and the information submission unit 704 may be further used for sending the payment account information to the server, so that the server performs the credit authority verification on the second user based on the payment account information.

In the other implementation as described above, when the payment account information opened by the second user in the payment platform associated with the server is obtained, a first graphic code information provided by the second user may be scanned to obtain information of a payment account opened by the second user in the payment platform associated with the server, the first graphic code information being provided by a payment platform client installed in a terminal device of the second user, and an association relationship existing between the payment platform client and the server.

In implementations, the information submission unit 704 may further be used for determining estimated consumption resource information and sending the estimated consumption resource information to the server when the identification information of the second user is sent to the server, so that the server performs the credit authority verification on the second user based on the estimated consumption resource information.

In practical applications, the first user data processing system may include a hotel data processing system, and the service order includes a hotel service order.

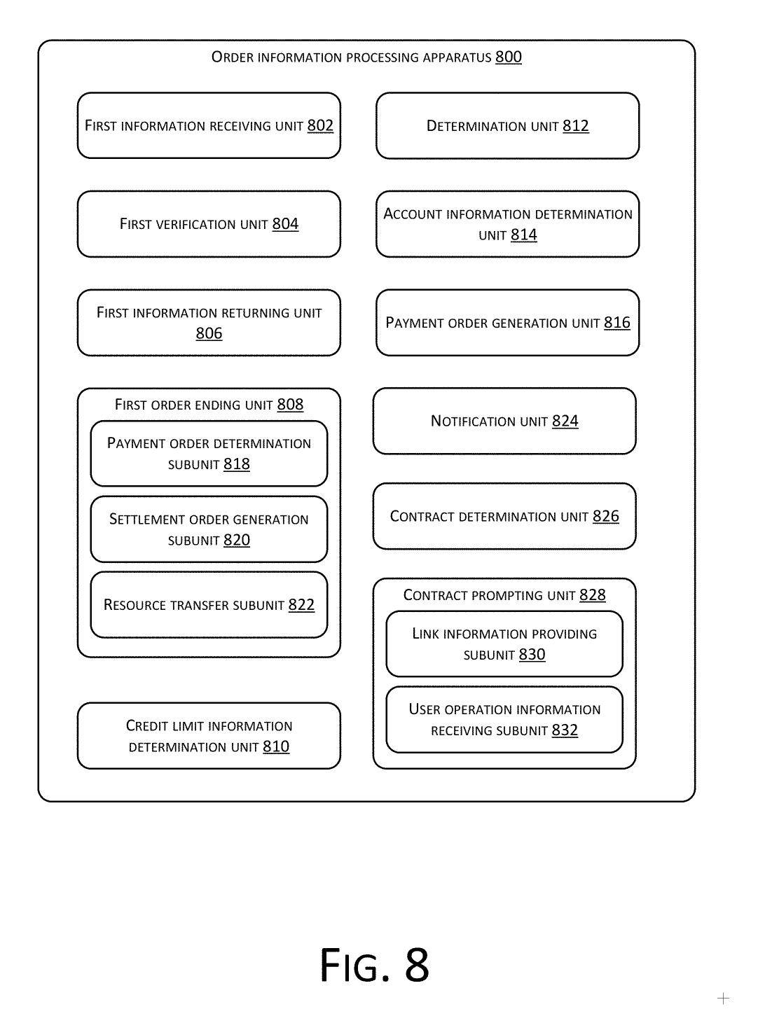

Corresponding to the third embodiment, the embodiments of the present disclosure further provide an order information processing apparatus 800, which may be applied in a server. Referring to FIG. 8, the apparatus 800 may include a first information receiving unit 802 used for receiving identification information of a second user; a first verification unit 804 used for performing credit authority verification on the second user; a first information returning unit 806 used for returning a message indicating that the verification is passed to a first user data processing system if the verification is passed, to cause the first user data processing system to generate a service order; and a first order ending unit 808 used for receiving consumption resource information of the service order submitted by the first user data processing system, and ending the service order according to the consumption resource information and payment account information associated with the second user.

In implementations, the first information receiving unit 802 may further be used for receiving identity document information of the second user sent by the first user data processing system, and the first verification unit 804 may further be used for determining the payment account information opened by the second user in a payment platform associated with the server according to the identity document information, and performing the credit authority verification on the second user based on the payment account information.

Alternatively, in implementations, the first information receiving unit 802 may further be used for receiving the payment account information that is opened by the second user in a payment platform associated with the server from the first user data processing system, and the verification unit 804 may further be used for performing the credit authority verification on the second user based on the payment account information.

In implementations, the first information receiving unit 802 may further be used for receiving the estimated consumption resource information, and the apparatus 800 may further include a credit limit information determination unit 810 used for determining credit limit information of the second user; and a determination unit 812 used for determining whether the credit limit information is higher than the estimated consumption resource information, and determining whether the verification is passed based on a determination result.

In addition, the apparatus 800 may further include an account information determination unit 814 used for determining collection account information associated with the first user when receiving information of the service order submitted by the first user data processing system; and a payment order generation unit 816 used for binding the determined collection account information of the first user, the payment account information of the second user, and the service order together to generate a payment order.

At this time, the first order ending unit 808 may include a payment order determination subunit 818 used for determining the payment order associated with the service order; a settlement order generation subunit 820 used for generating a settlement order based on the actual consumption resource information and information recorded in the payment order; and a resource transfer subunit 822 used for allocating the corresponding actual consumption resource information from a payment account of the second user to a collection account of the first user according to the settlement order.

In addition, the apparatus 800 may further include a notification unit 824 used for providing a notification message regarding a transfer of the resource information to a client of the second user.

In implementations, the apparatus 800 may further include a contract determination unit 826 used for determining whether the second user belongs to a contracted user; and a contract prompting unit 828 used for prompting the second user to sign a contract if not yet signed.

If the received identification information of the second user includes contact information of the second user, the contract prompting unit 828 may include a link information providing subunit 830 used for providing information of a link for jumping to a contract signing page to the second user using the contact information; and a user operation information receiving subunit 832 used for completing a contract signing operation by receiving the user operation information sent by the client of the second user.

Alternatively, in implementations the contract prompting unit 828 may be used for providing prompt information indicating that the second user has not signed a contract to the first user data processing system, and performing an option of operation of contract signing, so that operation information of the first user is received through the option of operation after the second user agrees to sign the contract, and a contract signing operation is completed.

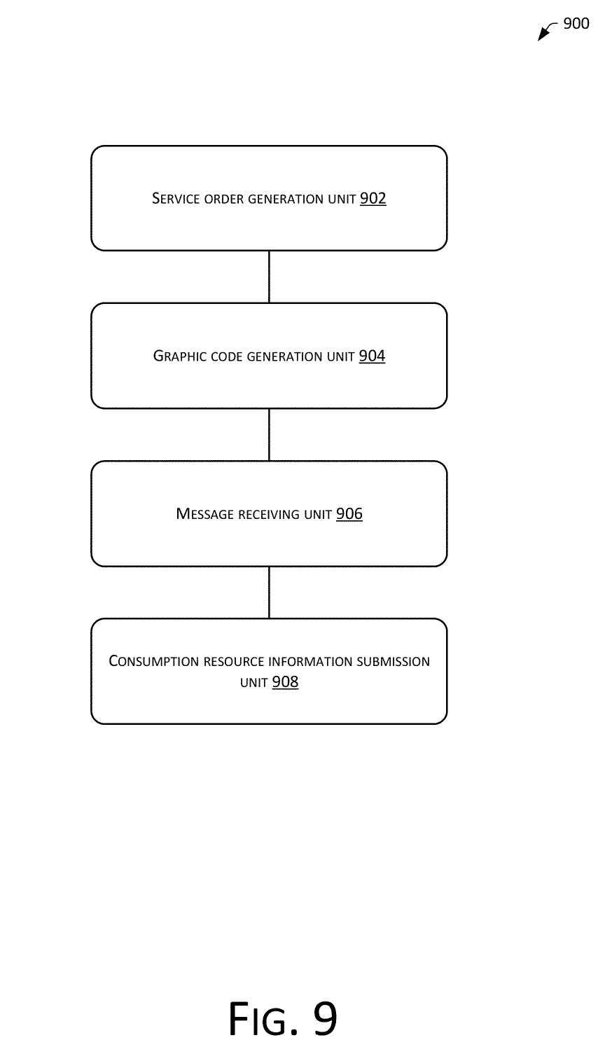

Corresponding to the fourth embodiment, the embodiments of the present disclosure further provide an order information processing apparatus 900, which is applied in a first user data processing system. Referring to FIG. 9, the apparatus 900 may specifically include a service order generation unit 902 used for generating a service order according to a service request of a second user; a graphic code generation unit 904 used for generating a second graphic code according to information of the service order, so that a client of the second user scans the second graphic code when a payment account associated with the second user is logged in, and submits payment account information and service order information that is scanned to a server, and the server performs credit authority verification on the second user according to the payment account information, and returns a message indicating that the verification is passed to the first user data processing system if the verification is passed; a message receiving unit 906 used for receiving the message indicating that the verification is passed; and a consumption resource information submission unit 908 used for submitting consumption resource information of the service order to the server, to cause the server to end the service order according to the consumption resource information and the payment account information associated with the second user.

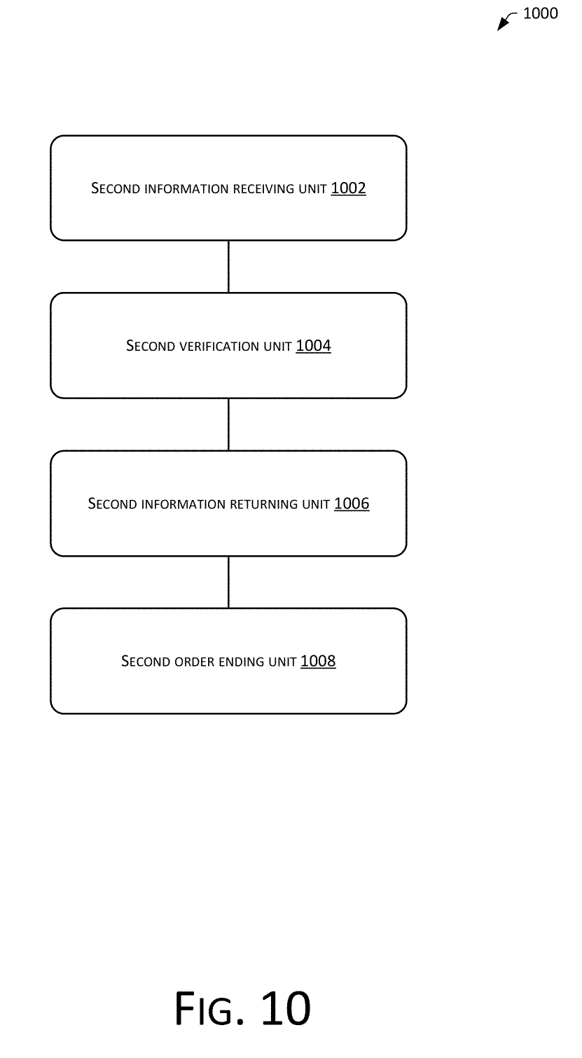

Corresponding to the fifth embodiment, the embodiments of the present disclosure further provide an order information processing apparatus, which is applied in a server. Referring to FIG. 10, the apparatus may include a second information receiving unit 1002 used for receiving service order information submitted by a client of a second user and payment account information of the second user, wherein the service order is generated by a first user data processing system according to a service request of the second user; a second verification unit 1004 used for performing credit authority verification on the second user according to the payment account information; a second information returning unit 1006 used for returning a message indicating that the verification is passed to the first user data processing system if the verification is passed, to cause the first user data processing system to generate the service order; and a second order ending unit 1008 used for ending the service order according to consumption resource information of the service order submitted by the first user data processing system and the payment account information associated with the second user in response to receiving the consumption resource information.

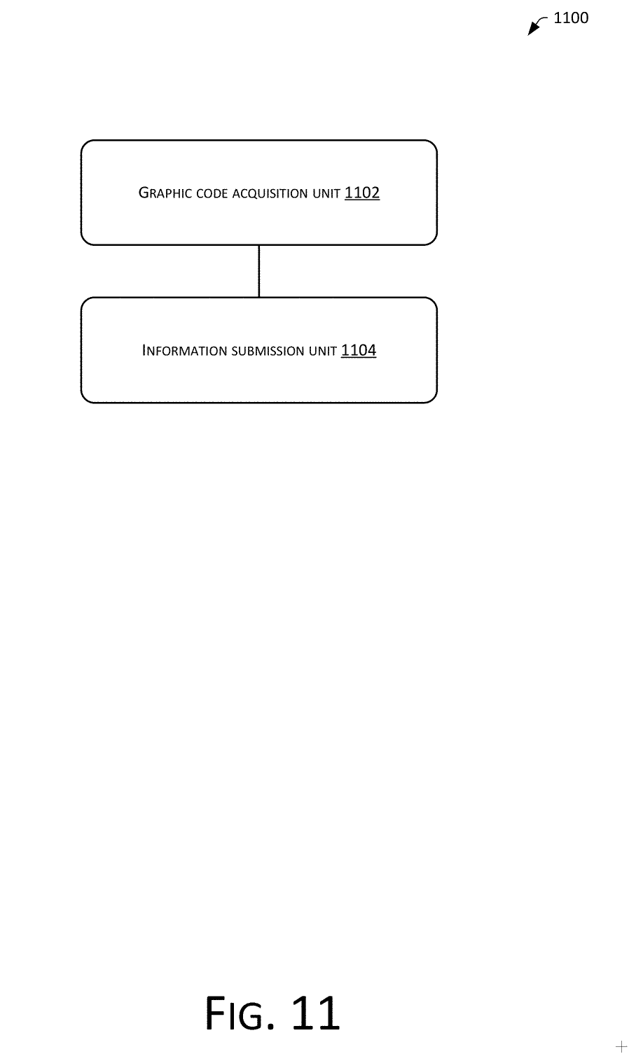

Corresponding to the sixth embodiment, the embodiments of the present disclosure further provides an order information processing apparatus 1100, which is applied in a client of a second user. Referring to FIG. 11, the apparatus 1100 may include a graphic code acquisition unit 1102 used for obtaining a second graphic code provided by a first user data processing system in a condition that a payment account associated with the second user is logged in, wherein the second graphic code carries service order information generated by the first user data processing system according to a service request of the second user; and an information submission unit 1104 used for submitting payment account information associated with the second user and the service order information in the second graphic code to a server, so that the server performs credit authority verification on the second user according to the payment account information, and returns a message indicating that the verification is passed to the first user data processing system if the verification is passed, wherein the server ends the service order according to consumption resource information and the payment account information associated with the second user.

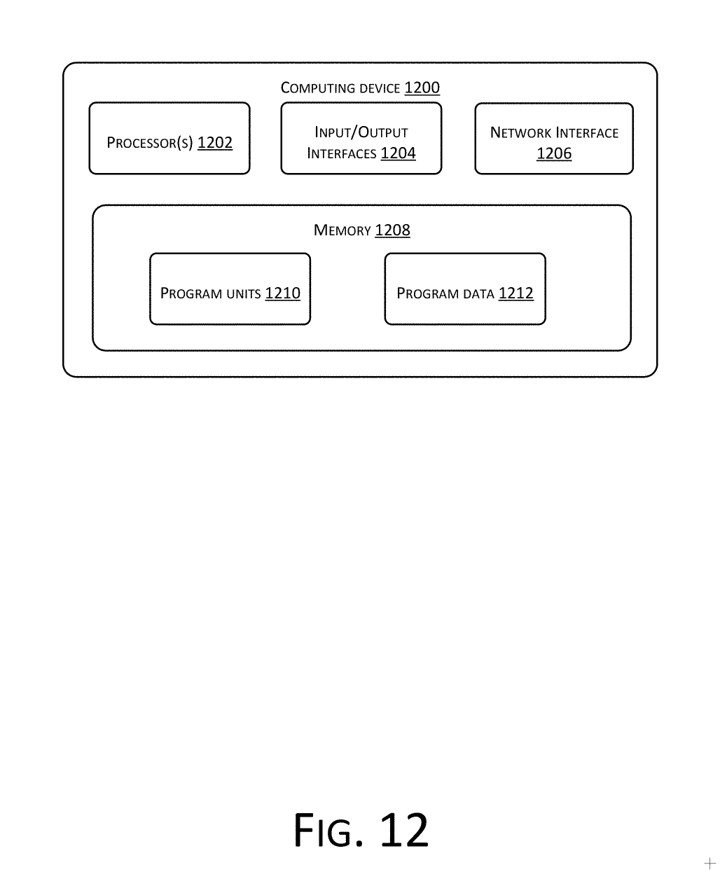

FIG. 12 shows an example computing device 1200. In implementations, the order information processing system 100, the first user data processing system 102, the server 104, the terminal device of the first user, and/or the terminal device of the second user may individually include one or more computing devices as shown in FIG. 12. By way of example and not limitation, the computing device 1200 may include one or more processors 1202, an input/output (I/O) interface 1204, a network interface 1206, and memory 1208.

The memory 1208 may include a form of computer readable media such as a volatile memory, a random access memory (RAM) and/or a non-volatile memory, for example, a read-only memory (ROM) or a flash RAM. The memory 1208 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1208 may include program units 1210 and program data 1212. Depending on which system, server or terminal device (e.g., the order information processing system 100, the first user data processing system 102, the server 104, the terminal device of the first user, the terminal device of the second user, etc.) that includes the computing device 1200, the program units 1212 may include one or more of the units and/or subunits as described in the foregoing description and shown in FIGS. 7-11.

Using the embodiments of the present disclosure, when receiving a service request of a second user, a first user data processing system only needs to submit identification information of the second user to a server. The server can perform credit authority verification on the second user, and perform a determination by judging whether a service condition is satisfied. If satisfied, the first user data processing system is informed to provide services to the current second user according to a preset manner (for example, deposit-free check-in, free of room inspection when leaving the hotel, etc.). At the end of the services, the server then performs a checkout operation for a corresponding order. Therefore, it is possible to avoid performing operations such as collecting a deposit, checking at the time of leaving the hotel, returning a deposit, etc., thus improving efficiency. At the same time, since operations of a process of paying for consumption resources swiping a card (which includes taking out the card, swiping the card, entering a password, and signing), paying cash (taking money, examining the money, giving out any change), etc., are skipped, the second user who is currently dealt with is prevented from waiting for a long period of time.

As can be known from the description of the foregoing implementations, one skilled in the art can clearly understand that the present disclosure can be implemented by means of software plus a necessary general hardware platform. Based on such understanding, the essence of technical solutions of the present disclosure or the parts that contribute to the existing technologies may be embodied in a form of a software product. The computer software product may be stored in a storage media such as a ROM/RAM, or a magnetic disk, an optical disk, etc., and includes instructions for causing a computing device (which may be a personal computer, a server, or a network device, etc.) to perform the methods described in various embodiments or parts of the embodiments of the present disclosure.

The various embodiments in the specification are described in a progressive manner, and same or similar parts of the various embodiments may be referenced to each other. Each embodiment put an emphasis on an aspect that is different from those of the other embodiments. In particular, due to substantially similarities to the method embodiments, the descriptions of the system or system embodiments are relatively simple, and the relevant parts can be referenced to the description of the method embodiments. The system and system embodiments as described above are merely illustrative. Units there are described therein as separate components may or may not be physically separate. Components that are displayed as units may or may not be physical units, i.e., can be located in a single place or can be distributed among multiple network units. Some or all of the modules may be selected according to actual requirements to achieve the purpose of the solutions of the embodiments. One of ordinary skill in the art can understand and implement thereof without making any creative effort.

The methods, apparatuses and systems for processing order information provided by the present disclosure are described in detail above. The principles and methods of implementations of the present disclosure are described using specific examples. The description of the above embodiments is only used for helping to understand the methods and their core ideas of the present disclosure. Furthermore, for one of ordinary skill in the art, there can be changes in specific implementations and application scopes according to the ideas of the present disclosure. In summary, the content of the present specification should not be construed as limiting the present disclosure.

The present disclosure can be further understood using the following clauses.

Clause 1: A system for processing order information, comprising: a first user data processing system and a server, wherein: the first user data processing system is configured to determine identification information of a second user and submit the identification information of the second user to the server when processing a service request of the second user; and the server is configured to perform credit authority verification on the second user, notify the first user data processing system to generate a service order if the verification is passed, and in response to receiving consumption resource information corresponding to the service order sent by the first user data processing system, end the service order according to the consumption resource information and payment account information associated with the second user.

Clause 2: A method for processing order information, comprising: determining, by a first user data processing system, identification information of a second user when processing a service request of the second user; sending the identification information of the second user to a server, to enable the server to perform credit authority verification on the second user; generating a service order and submitting the service order to the server after receiving a successful verification message; and sending consumption resource information of the service order to the server, to enable the server to end the service order according to the consumption resource information and payment account information associated with the second user.

Clause 3: The method of Clause 2, wherein determining the identification information of the second user comprises collecting identity document information of the second user, and sending the identification information of the second user to the server comprises sending the identity document information of the second user to the server to allow the server to determine information of a payment account opened by the second user in a payment platform that is associated with the server based on the identity document information of and to perform the credit authority verification on the second user based on the information of the payment account.

Clause 4: The method of Clause 2, wherein determining the identification information of the second user comprises obtaining information of a payment account opened by the second user in a payment platform associated with the server, and sending the identification information of the second user to the server comprises sending the information of the payment account to the server, so that the server performs the credit authority verification on the second user based on the information of the payment account.

Clause 5: The method of Clause 4, wherein obtaining the information of the payment account opened by the second user in the payment platform associated with the server comprises scanning a first graphic code information provided by the second user to obtain the information of the payment account opened by the second user in the payment platform associated with the server, the first graphic code information being provided by a payment platform client installed in a terminal device of the second user, and an association relationship existing between the payment platform client and the server.

Clause 6: The method of any one of Clauses 2-5, wherein: when sending the identification information of the second user to the server, the method further comprises determining estimated consumption resource information and sending the estimated consumption resource information to the server when the identification information of the second user is sent to the server, so that the server performs the credit authority verification on the second user based on the estimated consumption resource information.

Clause 7: The method of any one of Clauses 2-5, wherein the first user data processing system comprises a hotel data processing system, and the service order includes a hotel service order.

Clause 8: A method for processing order information, comprising: receiving, by a server, identification information of a second user; performing credit authority verification on the second user; if the verification is passed, returning a message indicating that the verification is passed to a first user data processing system, to cause the first user data processing system to generate a service order; and receiving consumption resource information of the service order submitted by the first user data processing system, and ending the service order according to the consumption resource information and payment account information associated with the second user.

Clause 9: The method of Clause 8, wherein receiving the identification information of the second user comprises receiving identity document information of the second user sent by the first user data processing system, and performing the credit authority verification on the second user comprises determining the payment account information opened by the second user in a payment platform associated with the server according to the identity document information, and performing the credit authority verification on the second user based on the payment account information.

Clause 10: The method of Clause 8, wherein receiving the identification information of the second user comprises receiving the payment account information that is opened by the second user in a payment platform associated with the server from the first user data processing system, and performing the credit authority verification on the second user comprises performing the credit authority verification on the second user based on the payment account information.

Clause 11: The method of Clause 8, wherein the information sent by the first user data processing system further comprises estimated consumption resource information, and performing the credit authority verification on the second user comprises: determining credit limit information of the second user; and determining whether the credit limit information is higher than the estimated consumption resource information, and determining whether the verification is passed based on a determination result.

Clause 12: The method of Clause 8, further comprising: determining collection account information associated with the first user when receiving information of the service order sent by the first user data processing system; and binding the determined collection account information of the first user, the payment account information of the second user, and the service order together to generate a payment order, wherein ending the service order according to the consumption resource information and the payment account information associated with the second user comprises: determining a payment order associated with the service order; generating a settlement order based on the consumption resource information and information recorded in the payment order; and allocating the consumption resource information from a payment account of the second user to a collection account of the first user according to the settlement order.

Clause 13: The method of claim 12, further comprising providing a notification message regarding a transfer of the resource information to a client of the second user.

Clause 14: The method of Clause 8, wherein: prior to performing the credit authority verification on the second user, the method further comprises: determining whether the second user belongs to a contracted user; and prompting the second user to sign a contract if not yet signed.

Clause 15: The method of Clause 14, wherein the received identification information of the second user includes contact information of the second user, and prompting the second user to sign the contract comprises: providing information of a link for jumping to a contract signing page to the second user using the contact information; and completing a contract signing operation by receiving the user operation information sent by the client of the second user.

Clause 16: The method of Clause 14, wherein prompting the second user to sign the contract comprises providing prompt information indicating that the second user has not signed the contract to the first user data processing system, and performing an option of operation of contract signing, so that operation information of the first user is received through the option of operation after the second user agrees to sign the contract, and a contract signing operation is completed.

Clause 17: A method for processing order information, comprising: generating, by a first user data processing system, a service order according to a service request of a second user; generating a second graphic code according to information of the service order, so that a client of the second user scans the second graphic code when a payment account associated with the second user is logged in, and sends payment account information and service order information that is scanned to a server, and the server performs credit authority verification on the second user according to the payment account information, and returns a message indicating that the verification is passed to the first user data processing system if the verification is passed; receiving the message indicating that the verification is passed; and sending consumption resource information of the service order to the server, to cause the server to end the service order according to the consumption resource information and the payment account information associated with the second user.

Clause 18: A method for processing order information, comprising: receiving, by a server, service order information submitted by a client of a second user and payment account information of the second user, wherein the service order is generated by a first user data processing system according to a service request of the second user; performing credit authority verification on the second user according to the payment account information; returning a message indicating that the verification is passed to the first user data processing system if the verification is passed, to cause the first user data processing system to generate the service order; and ending the service order according to consumption resource information of the service order submitted by the first user data processing system and the payment account information associated with the second user in response to receiving the consumption resource information.

Clause 19: A method for processing order information, comprising: obtaining, a client of a second user, a second graphic code provided by a first user data processing system in a condition that a payment account associated with the second user is logged in, wherein the second graphic code carries service order information generated by the first user data processing system according to a service request of the second user; and submitting payment account information associated with the second user and the service order information in the second graphic code to a server, so that the server performs credit authority verification on the second user according to the payment account information, and returns a message indicating that the verification is passed to the first user data processing system if the verification is passed, wherein the server ends the service order according to consumption resource information and the payment account information associated with the second user.

Clause 20: An apparatus for processing order information, which is applied in a first data user processing system, comprising: an identification information determination unit used for determining identification information of a second user when processing a service request of the second user; an information submission unit used for submitting the identification information of the second user to a server, to enable the server to perform credit authority verification on the second user; an order generation unit used for generating a service order and submitting the service order to the server after receiving a successful verification message; and a consumption resource information submission unit used for submitting consumption resource information of the service order to the server, to enable the server to end the service order according to the consumption resource information and payment account information associated with the second user.

Clause 21: An apparatus for processing order information, which is applied in a server, comprising: a first information receiving unit used for receiving identification information of a second user; a first verification unit used for performing credit authority verification on the second user; a first information returning unit used for returning a message indicating that the verification is passed to a first user data processing system if the verification is passed, to cause the first user data processing system to generate a service order; and a first order ending unit used for receiving consumption resource information of the service order submitted by the first user data processing system, and ending the service order according to the consumption resource information and payment account information associated with the second user.

Clause 22: An apparatus for processing order information, which is applied in a first data user processing system, comprising: a service order generation unit used for generating a service order according to a service request of a second user; a graphic code generation unit used for generating a second graphic code according to information of the service order, so that a client of the second user scans the second graphic code when a payment account associated with the second user is logged in, and submits payment account information and service order information that is scanned to a server, and the server performs credit authority verification on the second user according to the payment account information, and returns a message indicating that the verification is passed to the first user data processing system if the verification is passed; a message receiving unit used for receiving the message indicating that the verification is passed; and a consumption resource information submission unit used for submitting consumption resource information of the service order to the server, to cause the server to end the service order according to the consumption resource information and the payment account information associated with the second user.

Clause 23: An apparatus for processing order information, which is applied in a server, comprising: a second information receiving unit used for receiving service order information submitted by a client of a second user and payment account information of the second user, wherein the service order is generated by a first user data processing system according to a service request of the second user; a second verification unit used for performing credit authority verification on the second user according to the payment account information; a second information returning unit used for returning a message indicating that the verification is passed to the first user data processing system if the verification is passed, to cause the first user data processing system to generate the service order; and a second order ending unit used for ending the service order according to consumption resource information of the service order submitted by the first user data processing system and the payment account information associated with the second user in response to receiving the consumption resource information.

Clause 24: An apparatus for processing order information, which is applied in a client of a second user, comprising: a graphic code acquisition unit used for obtaining a second graphic code provided by a first user data processing system in a condition that a payment account associated with the second user is logged in, wherein the second graphic code carries service order information generated by the first user data processing system according to a service request of the second user; and an information submission unit used for submitting payment account information associated with the second user and the service order information in the second graphic code to a server, so that the server performs credit authority verification on the second user according to the payment account information, and returns a message indicating that the verification is passed to the first user data processing system if the verification is passed, wherein the server ends the service order according to consumption resource information and the payment account information associated with the second user.

What is claimed is:

1. A method implemented by a first user data processing system, the method comprising:
determining identification information of a second user when processing a service request of the second user;
sending the identification information of the second user to a server, to enable the server to perform credit authority verification on the second user;
generating a service order and submitting the service order to the server after receiving a successful verification message; and
sending consumption resource information of the service order to the server, to enable the server to end the service order according to the consumption resource information and payment account information associated with the second user.

2. The method of claim 1, wherein determining the identification information of the second user comprises collecting identity document information of the second user, and sending the identification information of the second user to the server comprises sending the identity document information of the second user to the server to allow the server to determine information of a payment account opened by the second user in a payment platform that is associated with the server based on the identity document information of and to perform the credit authority verification on the second user based on the information of the payment account.

3. The method of claim 2, wherein determining the identification information of the second user comprises obtaining information of a payment account opened by the second user in a payment platform associated with the server, and sending the identification information of the second user to the server comprises sending the information of the payment account to the server, so that the server performs the credit authority verification on the second user based on the information of the payment account.

4. The method of claim 3, wherein obtaining the information of the payment account opened by the second user in the payment platform associated with the server comprises scanning a first graphic code information provided by the second user to obtain information of a payment account is opened by the second user in the payment platform associated with the server, the first graphic code information being provided by a payment platform client installed in a terminal device of the second user, and an association relationship existing between the payment platform client and the server.

5. The method of claim 1, wherein: when sending the identification information of the second user to the server, the method further comprises determining estimated consumption resource information and sending the estimated consumption resource information to the server when the identification information of the second user is sent to the server, so that the server performs the credit authority verification on the second user based on the estimated consumption resource information.

6. The method of claim 1, wherein the first user data processing system comprises a hotel data processing system, and the service order includes a hotel service order.

7. One or more computer readable media storing executable instructions that, when executed by a server, cause the server to perform acts comprising:
receiving identification information of a second user;
performing credit authority verification on the second user; and
if the verification is passed, returning a message indicating that the verification is passed to a first user data processing system, to cause the first user data processing system to generate a service order; and
receiving consumption resource information of the service order submitted by the first user data processing system, and ending the service order according to the consumption resource information and payment account information associated with the second user.

8. The one or more computer readable media of claim 7, wherein receiving the identification information of the second user comprises receiving identity document information of the second user sent by the first user data processing system, and performing the credit authority verification on the second user comprises determining the payment account information opened by the second user in a payment platform associated with the server according to the identity document information, and performing the credit authority verification on the second user based on the payment account information.

9. The one or more computer readable media of claim 7, wherein receiving the identification information of the second user comprises receiving the payment account information that is opened by the second user in a payment platform associated with the server from the first user data processing system, and performing the credit authority verification on the second user comprises performing the credit authority verification on the second user based on the payment account information.

10. The one or more computer readable media of claim 7, wherein the information sent by the first user data processing system further comprises estimated consumption resource information, and performing the credit authority verification on the second user comprises:
determining credit limit information of the second user; and
determining whether the credit limit information is higher than the estimated consumption resource information, and determining whether the verification is passed based on a determination result.

11. The one or more computer readable media of claim 7, the acts further comprising:
determining collection account information associated with the first user when receiving information of the service order sent by the first user data processing system; and
binding the determined collection account information of the first user, the payment account information of the second user, and the service order together to generate a payment order, wherein ending the service order according to the consumption resource information and the payment account information associated with the second user comprises:
determining a payment order associated with the service order;
generating a settlement order based on the consumption resource information and information recorded in the payment order; and
allocating the consumption resource information from a payment account of the second user to a collection account of the first user according to the settlement order.

12. The one or more computer readable media of claim 11, the acts further comprising providing a notification message regarding a transfer of the resource information to a client of the second user.

13. The one or more computer readable media of claim 7, wherein: prior to performing the credit authority verification on the second user, the acts further comprise:
determining whether the second user belongs to a contracted user; and
prompting the second user to sign a contract if not yet signed.

14. The one or more computer readable media of claim 13, wherein the received identification information of the second user includes contact information of the second user, and prompting the second user to sign the contract comprises:
providing information of a link for jumping to a contract signing page to the second user using the contact information; and
completing a contract signing operation by receiving the user operation information sent by the client of the second user.

15. The one or more computer readable media of claim 13, wherein prompting the second user to sign the contract comprises providing prompt information indicating that the second user has not signed the contract to the first user data processing system, and performing an option of operation of contract signing, so that operation information of the first user is received through the option of operation after the second user agrees to sign the contract, and a contract signing operation is completed.

16. An apparatus implemented by a server comprising one or more processors and memory, the apparatus comprising:
a first information receiving unit stored in the memory and executed by the one or more processors to receive identification information of a second user;
a first verification unit stored in the memory and executed by the one or more processors to perform credit authority verification on the second user;
a first information returning unit stored in the memory and executed by the one or more processors to return a message indicating that the verification is passed to a first user data processing system if the verification is passed, to cause the first user data processing system to generate a service order; and
a first order ending unit stored in the memory and executed by the one or more processors to receive consumption resource information of the service order submitted by the first user data processing system, and ending the service order according to the consumption resource information and payment account information associated with the second user.

17. The apparatus of claim 16, wherein the first information receiving unit is further configured to receive identity document information of the second user sent by the first user data processing system, and the first verification unit is further configured to determine the payment account information opened by the second user in a payment platform associated with the server according to the identity document information, and performing the credit authority verification on the second user based on the payment account information.

18. The apparatus of claim 16, further comprising an account information determination unit configured to determine collection account information associated with the first user when receiving information of the service order submitted by the first user data processing system; and a payment order generation unit configured to bind the determined collection account information of the first user, the payment account information of the second user, and the service order together to generate a payment order.

19. The apparatus of claim 16, wherein the first order ending unit comprises a payment order determination subunit configured to determine the payment order associated with the service order; a settlement order generation subunit configured to generate a settlement order based on the actual consumption resource information and information recorded in the payment order; and a resource transfer subunit configured to allocate the corresponding actual consumption resource information from a payment account of the second user to a collection account of the first user according to the settlement order.

20. The apparatus of claim 16, further comprising a contract determination unit configured to determine whether the second user belongs to a contracted user; and a contract prompting unit configured to prompt the second user to sign a contract if not yet signed.
